(19) United States
(12) Patent Application Publication
(10) Pub. No.: US 2011/0214577 A1
(43) Pub. Date: Sep. 8, 2011

(54) APPARATUS FOR PRODUCING CONFECTIONERY

(75) Inventor: Hyung-Seob KIM, Seoul (KR)

(73) Assignee: DELICE CO., LTD., Seongnam-city (KR)

(21) Appl. No.: 12/836,751

(22) Filed: Jul. 15, 2010

(30) Foreign Application Priority Data
Mar. 8, 2010 (KR) 10-2010-0020530

(51) Int. Cl. A47J 43/00; B02C 21/00; B02C 9/02

(52) U.S. Cl. 99/537; 241/65; 241/277; 241/60

(57) ABSTRACT

Provided is an apparatus for producing confectionery including a grain supply unit installed on a main body and uniformly supplying grains inserted from the outside, a grain processing unit rotatably installed on the main body, receiving the grains and crushing the grains using a rotating spiral, and simultaneously discharging the grains in a jellylike state using frictional heat generated during collision of the grains, and a drive unit for driving the grain processing unit and the grain supply unit.

### CROSS-REFERENCE TO RELATED APPLICATION

This application claims the benefit of Korean Patent Application No. 2010-0020530, filed Mar. 8, 2010, the disclosure of which is hereby incorporated herein by reference in its entirety.

### BACKGROUND OF THE INVENTION

1. Field of the Invention

The present invention relates to an apparatus for producing confectionery and, more particularly to an apparatus for producing confectionery capable of processing and discharging a plurality of grains inserted in a dry state into soft jelly to form a predetermined length of confectionery by supplying a uniform amount of grains from a supply screw, and crushing the grains supplied by a rotary process screw during conveyance of the grains and simultaneously generating frictional heat to a certain temperature during collision of the grains.

2. Description of the Related Art

In general, a confectionery production apparatus produces a predetermined shape of confectionery (for example, popcorn) by supplying various grains and heating them to a certain temperature.

The confectionery production apparatus includes a main body, a hopper disposed at an upper portion of the main body and receiving a predetermined amount of grains, a mold heating the grains supplied from the hopper and puffing the grains, a grain conveyance unit supplying the grains to the mold, a driving unit driving the grain conveyance unit and the mold, a heating unit heating the mold, and so on.

In this confectionery production apparatus having the above constitution, when a predetermined amount of grains is inserted into and heated in the closed mold, the grains generate steam to rapidly increase a pressure in the mold. In this state, when the closed mold is instantly opened, the pressure is also instantly lowered so that the grains abruptly expand by several times or more. That is, the confectionery production apparatus utilizes this expansion.

However, since the confectionery production apparatus uses the process of heating and expanding the inserted grains, only the grains produced in a dry state can be obtained. That is, it is impossible to obtain the grains produced in a soft jellylike state depending on a user's need. In addition, the grains cannot be simultaneously conveyed, crushed and heated to continuously produce confectionery, and thus, a grain processing speed is also reduced.

Of course, while a heater or a burner may be installed to discharge grains in a soft jellylike state, the installation of the heater or burner causes the confectionery production apparatus to be complicated and increases the consumption of energy (gas, power, etc.).

As such, there is a need for a confectionery production apparatus capable of detecting insertion of grains and performing automatic operation without manipulation by a controller or manual operation by a user.

### SUMMARY OF THE INVENTION

In order to solve the foregoing and/or other problems, it is an aspect of the present invention to provide an apparatus for producing confectionery in which a predetermined amount of grains can be inserted into a process screw through a supply screw rotated at a predetermined speed so that the inserted grains can be processed and discharged with a uniform density and size.

It is another aspect of the present invention to provide an apparatus for producing confectionery capable of processing a plurality of grains inserted in a dry state to continuously discharge a soft jelly by crushing the grains during conveyance of the grains by a rotary process screw and simultaneously generating frictional heat to a certain temperature during collision of the grains.

Additional aspect and advantages of the present invention will be set forth in part in the description which follows and, in part, will be obvious from the description, or may be learned by practice of the invention.

The foregoing and/or other aspects of the present invention may be achieved by providing an apparatus for producing confectionery including: a grain processing unit installed on a main body, crushing inserted grains, and processing and discharging the grains in a jellylike state using frictional heat generated when the grains are crushed; a drive unit for driving the grain processing unit; and a controller for controlling the drive unit.

In addition, the grain processing unit may be configured to receive grains through a grain supply unit, and the grain supply unit may be configured to be rotated by drive of the drive unit.

Further, the grain processing unit may include a discharge pipe installed on the main body and having a second grain inlet port and a second grain discharge port on opposite sides thereof in a longitudinal direction; and a process screw installed in the discharge pipe and rotated by the drive unit to process the grains.

Furthermore, a spiral pipe, in which the process screw is inserted, may be installed in the discharge pipe, and a thread may be formed in an inner circumference of the spiral pipe to contact the process screw and crush the grains.

In addition, the grains may be processed into a jellylike state due to frictional heat generated during collision of the grains with the thread.

Further, the thread may have protrusions having the same or irregular shapes to increase crush efficiency of the grains.

Furthermore, the frictional heat may range from 110° C. to 120° C.

In addition, the thread formed in the inner circumference of the spiral pipe may be engaged with a spiral formed on an outer circumference of the process screw, and have a tapered shape such that a diameter thereof is gradually reduced toward the second grain discharge port.

Further, the grain supply unit may include a supply pipe installed on the main body and having a first grain inlet port and a first grain discharge port formed on opposite sides thereof in a longitudinal direction; and a supply screw installed in the supply pipe and rotated by the drive unit so as to guide the grains to the grain processing unit.

Furthermore, the apparatus may further include a cooling unit for cooling the grains discharged in a jellylike state.

In addition, the cooling unit may perform a cooling operation such that a frictional heat temperature in the grain processing unit is maintained within a range of 110° C. to 120° C.

Further, the apparatus may further include a cutting unit operated under control of the controller to cut the grains discharged in a jellylike state or a cooled state into a certain length.

Furthermore, the apparatus may further include a grain detection unit for detecting a supply state of the grain from the grain supply unit to the grain processing unit and then outputting the detection signal to the controller.

In addition, the controller may be configured to drive the drive unit only when the detection signal of the grain detection unit is applied.

Further, the apparatus may further include an opening/closing unit operated under control of the controller to be converted into a grain blocking state when a temperature in the grain processing unit is equal to or lower than a preset reference temperature and converted into a grain insertion state when the temperature in the grain processing unit is higher than the preset reference temperature.

Furthermore, the controller may have a set value of the reference temperature for the temperature in the grain processing unit to control opening/closing operation of the opening/closing unit.

In addition, the cooling unit may include a housing installed in the second grain discharge port and having an air circulation path formed therein; and an air supply part connected to the path to circulate air and cool the discharge pipe through which the grains in a jellylike state are discharged.

Further, the cutting unit may include at least one cutting blade rotatably connected to the main body via a shaft and rotated about the shaft; and a drive part connected to the shaft of the cutting blade and driven under control of the controller to transmit a rotational force.

Furthermore, the cutting blade may have a concave part formed at a rotational end to cut the discharged grains while surrounding the grains.

In addition, the grain detection unit may be installed on a sidewall in the first grain inlet port to detect insertion of the grains from the grain supply unit to the grain processing unit.

Further, the opening/closing unit may include a through-hole formed on one side of the second grain inlet port; an operation member installed in the second grain inlet port to project from and withdraw into the through-hole and moving to an opening or closing position to determine insertion of the grains to the grain processing unit; a drive part driven under control of the controller and moving the operation member to the opening or closing position; and a temperature sensor for detecting a temperature in the second grain inlet port and applying a temperature detection signal to the controller.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a perspective view of an apparatus for producing confectionery in accordance with a first exemplary embodiment of the present invention;

FIG. 2 is an enlarged perspective view of a portion of the confectionery production apparatus, at which a grain supply unit is installed, in accordance with a first exemplary embodiment of the present invention;

FIG. 3 is an enlarged perspective view of a portion of the confectionery production apparatus, at which a grain processing unit is installed, in accordance with a first exemplary embodiment of the present invention;

FIG. 4 is a cross-sectional view of the grain processing unit of the confectionery production apparatus in accordance with a first exemplary embodiment of the present invention;

FIG. 5 is an exploded perspective view of the grain processing unit of the confectionery production apparatus in accordance with a first exemplary embodiment of the present invention, showing a cooling unit, a spiral pipe, and a hopper;

FIG. 6 is an enlarged perspective view of a portion of the confectionery production apparatus, at which a cutting unit is installed, in accordance with an exemplary embodiment of the present invention;

FIG. 7 is a schematic cross-sectional view of a grain supply unit of a confectionery production apparatus in accordance with a second exemplary embodiment of the present invention, in which a grain detection sensor is further installed;

FIG. 8 is a schematic cross-sectional view of a grain processing unit of a confectionery production apparatus in accordance with a third exemplary embodiment of the present invention, in which an opening/closing unit is installed;

FIG. 9 is a schematic cross-sectional view of the confectionery production apparatus in accordance with a third exemplary embodiment of the present invention, showing a state in which the opening/closing unit is opened for insertion of grains; and

FIG. 10 is a schematic cross-sectional view of a spiral pipe in accordance with an exemplary embodiment of the present invention.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below in order to explain the present invention by referring to the figures.

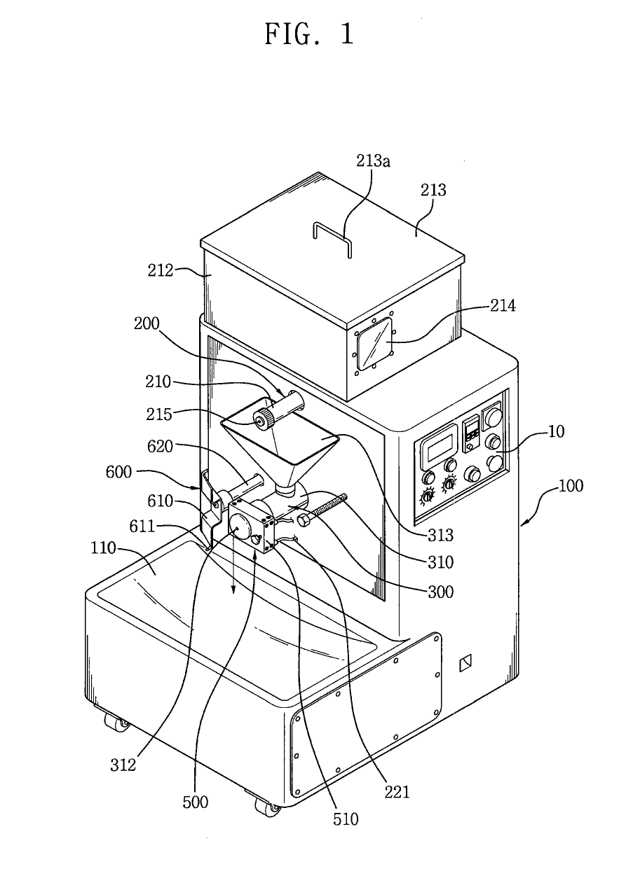

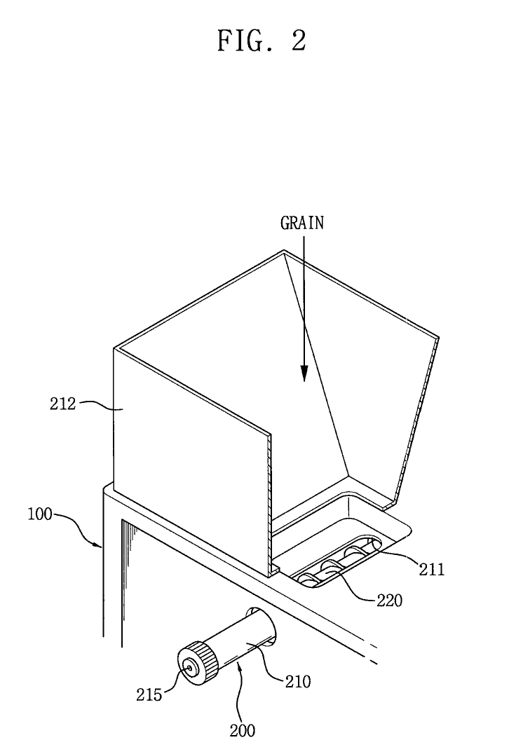

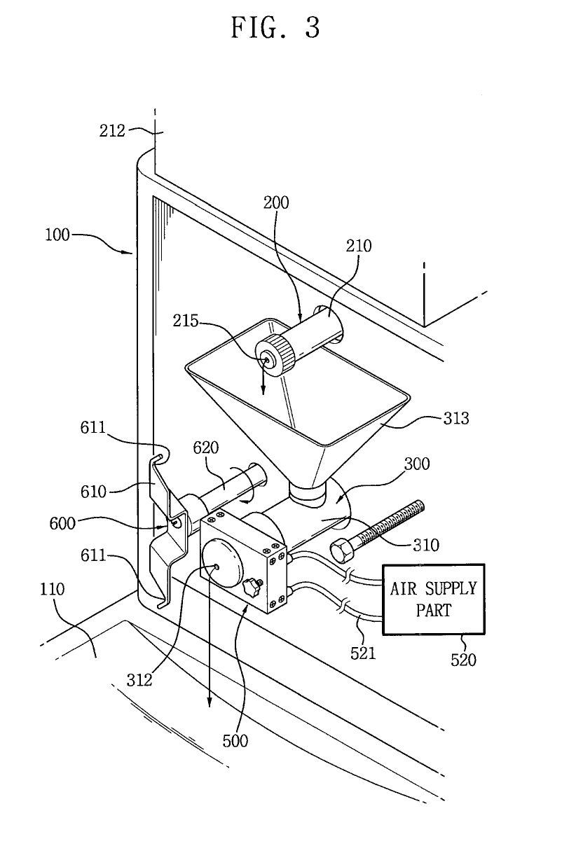

FIG. 1 is a perspective view of an apparatus for producing confectionery in accordance with a first exemplary embodiment of the present invention, FIG. 2 is an enlarged perspective view of a portion of the confectionery production apparatus, at which a grain supply unit is installed, in accordance with a first exemplary embodiment of the present invention, and FIG. 3 is an enlarged perspective view of a portion of the confectionery production apparatus, at which a grain processing unit is installed, in accordance with a first exemplary embodiment of the present invention.

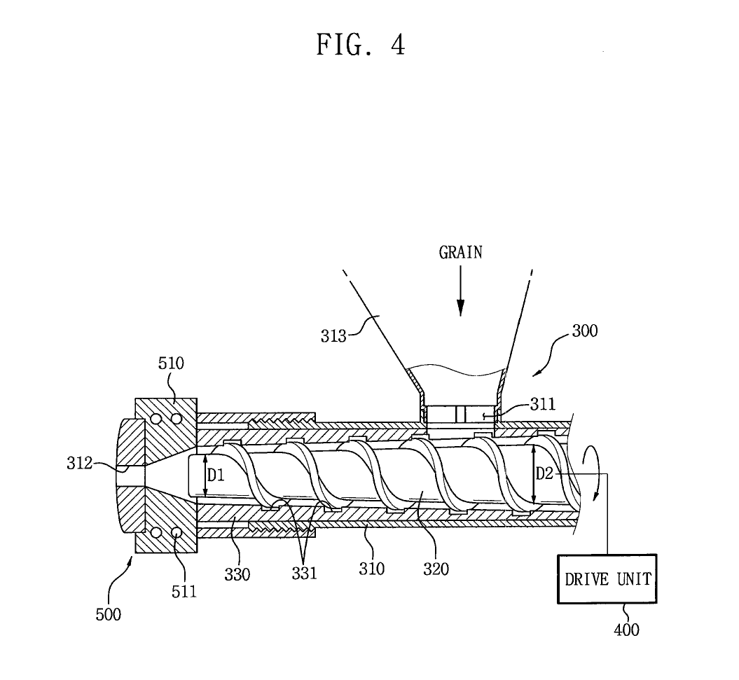

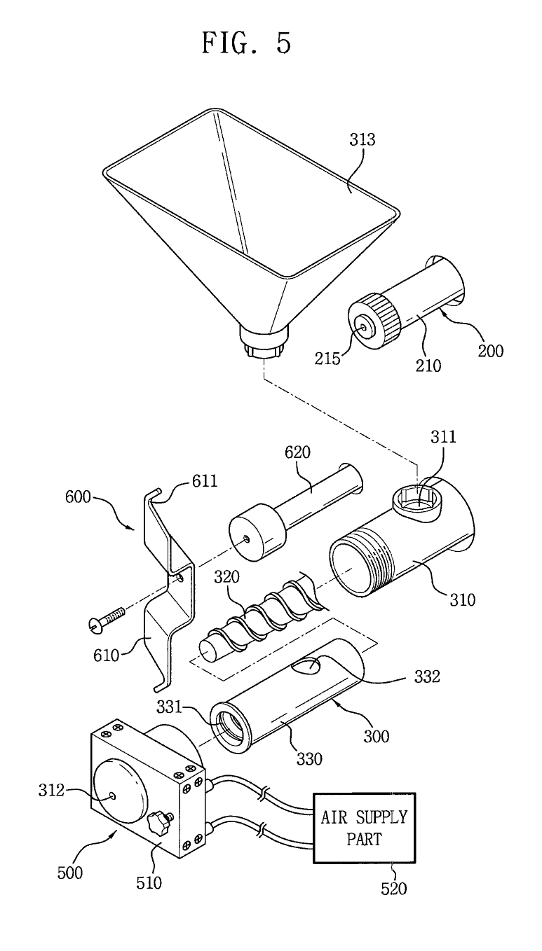

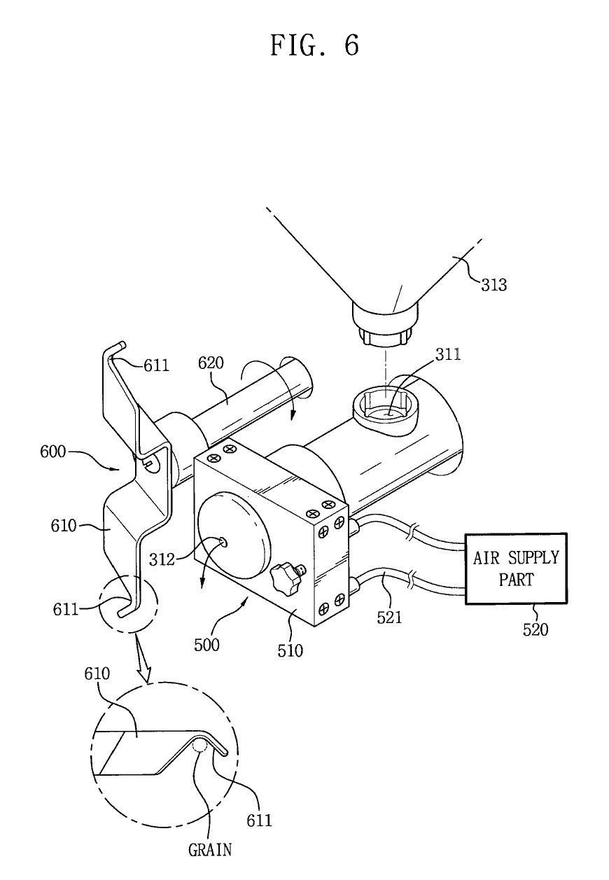

FIG. 4 is a cross-sectional view of the grain processing unit of the confectionery production apparatus in accordance with a first exemplary embodiment of the present invention, FIG. 5 is an exploded perspective view of the grain processing unit of the confectionery production apparatus in accordance with a first exemplary embodiment of the present invention, showing a cooling unit, a spiral pipe, and a hopper, and FIG. 6 is an enlarged perspective view of a portion of the confectionery production apparatus, at which a cutting unit is installed, in accordance with an exemplary embodiment of the present invention.

As shown in FIGS. 1 to 6, the confectionery production apparatus in accordance with a first exemplary embodiment of the present invention includes a main body 100, a grain supply unit 200, a grain processing unit 300, and a drive unit 300, as well as a cooling unit 500, and a cutting unit 600.

The main body 100 has a box shape in which a space is provided, and includes a receipt part 110 disposed at a lower portion thereof and receiving grains discharged from the grain processing unit 300. Here, the receipt part 110 may protrude from one side of the main body 100, and may have a recess formed in an upper surface thereof.

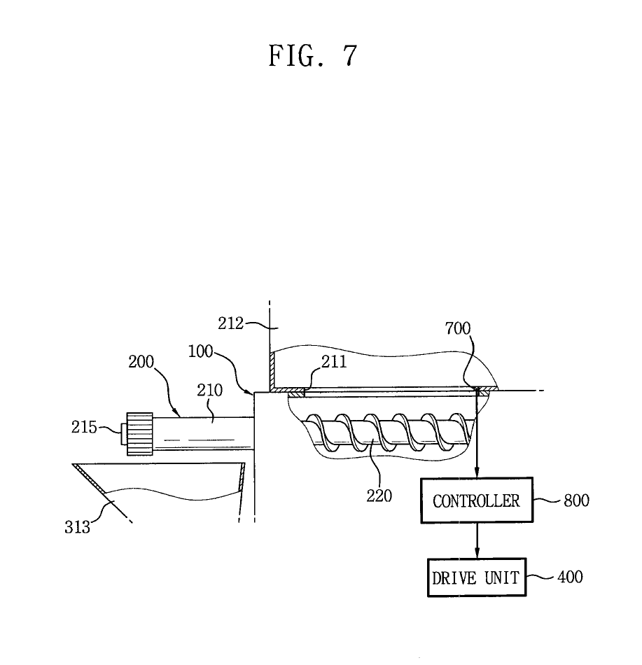

In addition, a control panel 120 having at least one operation key, a display window, etc. is installed on one surface of the main body 100 to manually operate the respective components of the confectionery production apparatus. The control panel 120 includes a controller 800 shown in FIGS. 7 to 9. The controller 800 controls the drive unit 400 according to a manual operation signal of the control panel 120.

Further, at least one wheel may be installed on the lower portion of the main body 100 to easily move the confectionery production apparatus.

Among the above components, the grain supply unit 200 is installed on an upper portion of the main body 100 to uniformly discharge the inserted grains to the lower portion of the main body 100, and includes a supply pipe 210 fixedly installed on the main body 100 and having a first grain inlet port 211 formed on one side in a longitudinal direction and a first grain discharge port 215 formed on the other side, and a supply screw 220 installed in the supply pipe 210 and rotated by the drive unit 400.

Next, the grain processing unit 300 is rotatably installed at the main body 100 to receive a certain amount of grains uniformly discharged from the grain supply unit 200 to crush the grains using a spiral protruding from an outer circumference thereof and simultaneously discharge the grains in a jellylike state using frictional heat generated during collision of the grains.

Here, the grain processing unit 300 may be uniformly supplied with the grains by the grain supply unit 200. Here, this supply unit is not essential. An operator may directly supply the grains into the grain processing unit 300 without passing through the grain supply unit 200. In the following description, the grains will be described as being uniformly supplied through the grain supply unit 200.

In addition, the frictional heat may be maintained at a temperature of about 110° C. to about 120° C. This temperature can be appropriately maintained by the cooling unit, which will be described below, without an excessive increase.

Next, the grain processing unit 300 is fixedly installed on the main body, and includes a discharge pipe 310 having a second grain inlet port 311 formed on one side in a longitudinal direction and a second grain discharge port 312 formed on the other end, and a process screw 320 abutting the interior of the discharge port 310 and installed to be rotated by the drive unit 400.

Further, a separate spiral pipe 330, in which a process screw 320 is rotatably installed, may be further fixedly installed in the discharge pipe 310. A thread 331 is formed in an inner circumference of the spiral pipe 330 so as to contact the process screw 320.

Furthermore, a through-hole 332 may be formed at one side of the spiral pipe 330 to communicate with the second grain inlet port 311.

Here, as shown in FIGS. 4 and 5, and 8 and 9, the thread 331 formed in the inner circumference of the spiral pipe 330 is engaged with the spiral formed on the outer circumference of the process screw 320, and has a tapered shape in a lengthwise direction (D2→D1) such that the diameter thereof is gradually reduced from the second grain inlet port 311 to the second grain discharge port 312. This is to provide easy conveyance and to increase a discharge pressure for easy discharge when the grains conveyed along the discharge pipe 310 are discharged through the second grain discharge port 312.

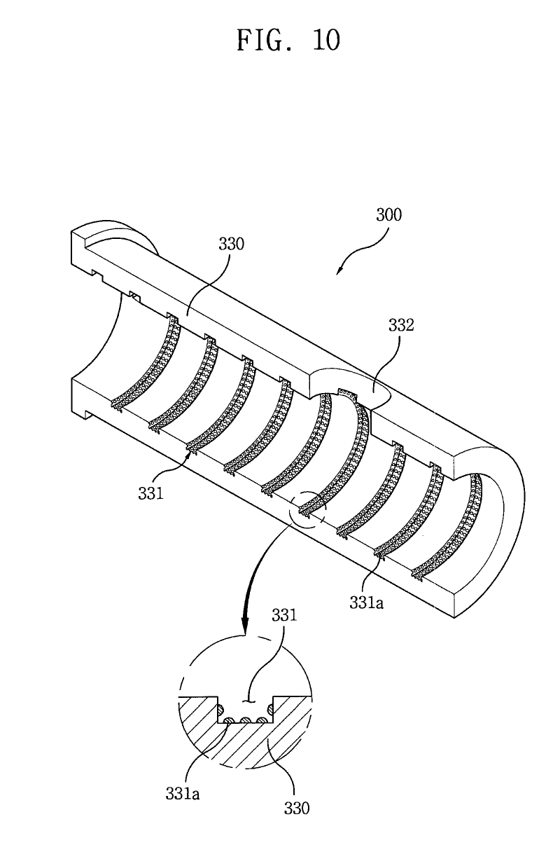

In addition, the thread 331 may have protrusions 331a having the same or irregular embossing shapes as shown in FIG. 10, and the spiral (no reference number) of the process screw 320 may also have protrusions having the same or irregular embossing shapes. Thus, grain crushability can be further improved.

A first hopper 212 may be separately coupled to an upper part of the first grain inlet port 211 to guide grains in a downward direction. In addition, a second hopper 313 may be coupled to an upper part of the second grain inlet port 311 to guide grains in a downward direction.

Here, a cover 213 may be further installed on an upper portion of the first hopper 212, and the cover 312 may have a handle 213a to allow a user to readily open/close the cover 213. Therefore, it is possible to prevent foreign substances such as dust entering with the grains from being inserted through the first hopper 212.

In addition, a transparent window 214 may be further installed on one surface of the first hopper 213 such that a user can watch the insertion of grains. That is, the insertion amount and consumption amount of the grains can be easily checked with the naked eye.

Next, the drive unit 400 is a conventional force transmission mechanism for transmitting a rotational force to the grain supply unit 200 and the grain processing unit 300, and while constitution thereof is not shown, may include a driving motor installed on the main body 100 and driven under control of a controller, and a chain connected to a driving shaft of the driving motor on one side and connected to the supply screw 220 and the process screw 320 to transmit a rotational force.

While not shown, the driving shaft of the driving motor, the supply screw 220 and the process screw 320 may be connected through a plurality of gears.

That is, the gear installed on the driving shaft of the driving motor, the supply screw 220, and the gear of the process screw 320 may be organically engaged with each other to be rotated.

Next, the cooling unit 500 is installed to prevent a discharge pipe 310 from being excessively heated to a predetermined temperature or more, and may include a housing 510 installed around the second grain discharge port 312 and having an air circulation path 511 formed therein, and an air supply part 520 connected to the path 511 and circulating air. If necessary, the cooling unit 500 may be used to cool the grains in a jellylike state discharged through the second grain discharge port 312.

Here, the air supply part 520 may be installed on the main body 100, and the air supply part 520 and the path 511 may be connected to each other through a hose 521 for supplying and discharging air.

Next, the cutting unit 600 is provided to cut the grains in a jellylike state discharged through the second grain discharge port 312, and may include at least one cutting blade 610 fixed to a shaft 620 rotatably connected to the main body 100, and a cutting drive part (not shown) connected to the shaft 620 and driven to transmit a rotational force under control of the controller.

Here, the cutting blade 610 may have a concave part 611 formed at a rotational end to cut the grains discharged through the second grain discharge port 312 while surrounding the grains as shown in FIG. 6.

As described above, in the confectionery production apparatus according to a first exemplary embodiment of the present invention, as shown in FIGS. 1 to 6, when the grains are inserted through the grain supply unit 200 to be guided to the grain processing unit 300, the grain processing unit 300 discharges the grains in a jellylike state using frictional heat. At this time, a discharged confectionery in a jellylike state is cut by the cutting unit 600 into certain lengths and then freely dropped into the receipt part 110 of the main body 100.

While the grains from the grain processing unit 300 are being processed and discharged in a jellylike state, the grains processed in a jellylike state can be hardened into a stick shape of confectionery having certain lengths through cooling of the cooling unit 500 upon discharge thereof. When the grains are cut into a certain length by the cutting unit 600, the confectionery is freely dropped into the receipt part 110 of the main body 100 to be stored in a hard stick shape rather than a soft jellylike state.

Meanwhile, FIG. 7 is a schematic cross-sectional view of a grain supply unit of a confectionery production apparatus in accordance with a second exemplary embodiment of the present invention, in which a grain detection sensor is further installed. The confectionery production apparatus in accordance with a second exemplary embodiment of the present invention will be described as follows, and description of the same components as described above will not be repeated.

The confectionery production apparatus in accordance with a second exemplary embodiment of the present invention includes a main body 100, a grain supply unit 200, a grain processing unit 300, a drive unit 400, and a grain detection sensor 700, and a controller 800.

As shown in FIG. 7, the grain detection sensor 700 is installed on a sidewall in the first grain inlet port 211 to detect the inserted grains. Here, the grain detection sensor 700 may be an optical sensor.

Therefore, when the grain detection sensor 700 detects the grains supplied to the grain supply unit 200, only when the detection signal is applied to the controller 800, does the controller 800 drive the drive unit 400 so that the grains are processed into a jellylike state by the grain processing unit 300.

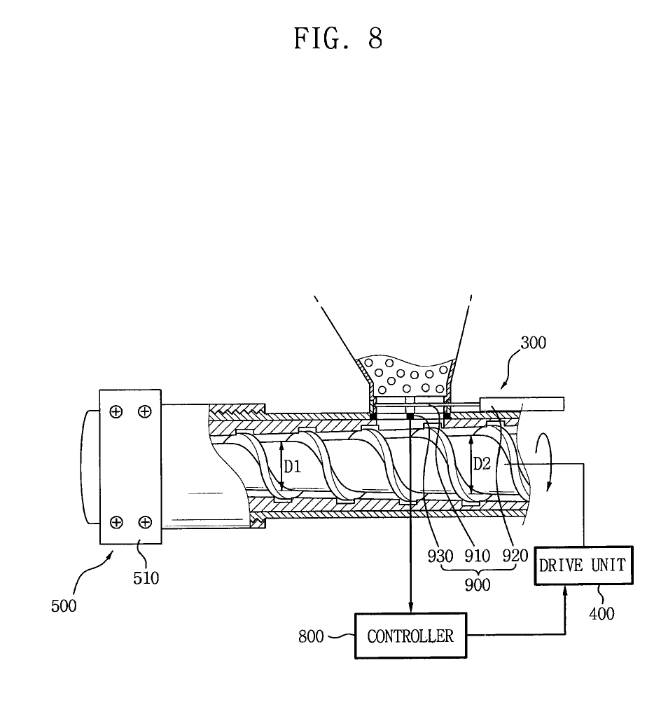

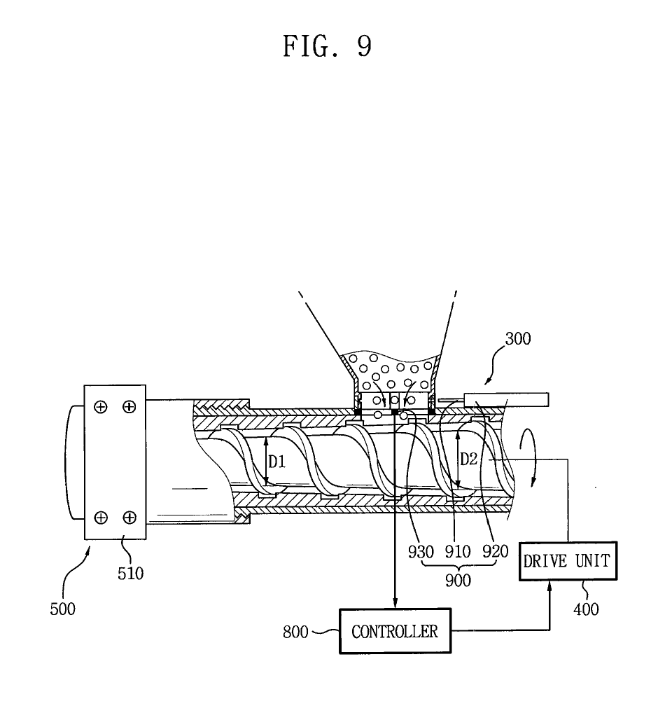

Meanwhile, FIG. 8 is a schematic cross-sectional view of a grain processing unit of a confectionery production apparatus in accordance with a third exemplary embodiment of the present invention, in which an opening/closing unit is installed, and FIG. 9 is a schematic cross-sectional view of the confectionery production apparatus in accordance with a third exemplary embodiment of FIG. 8, wherein an opening/closing unit is opened to insert grains. The third embodiment of the present invention further includes an opening/closing unit 900 for converting its operation into a grain blocking state when a temperature in the grain processing unit 300 is equal to or lower than a reference temperature set by the controller 800, and converting its operation into a grain insertion state when the temperature is higher than the reference temperature.

For this purpose, as shown in FIGS. 8 and 9, a through-hole 311a is formed at one side of the second grain inlet port 311. In addition, the opening/closing unit 900 may further include an operation member 910 protruding or withdrawing through the through-hole 311a of the second grain inlet port 311 to move to an opening or closing position of insertion of the grains, an opening/closing drive part 920 for moving the operation member 910 to the opening or closing position, and a temperature sensor 930 for detecting a temperature in the second grain inlet part 311 and applying a temperature detection signal to the controller 800.

That is, when the detection temperature applied from the temperature sensor 930 is equal to or lower than the preset reference temperature, the controller 800 may interrupt force transmitted to the drive unit 400 so as not to operate the drive unit 400. Here, the reference temperature set by the controller 800 may range from 110° C. to 120° C.

On the other hand, when the detection temperature of the temperature sensor 930 is higher than the reference temperature set by the controller 800, the force may be transmitted to the drive unit 400 to operate the drive unit 400. That is, the confectionery production apparatus may be operated only when the apparatus is preheated to a temperature equal to or higher than the reference temperature set by the controller 800.

In addition, the opening/closing drive part 920 may be a cylinder having a rod connected to the operation member 910. That is, as the rod of the cylinder protrudes and withdraws, the operation member 910 may horizontally move to the opening or closing position of the second grain inlet port 311.

While not shown, the operation member 910 may have a structure that opens and closes on one side so as to pivot about a hinge shaft without moving in a horizontal direction. That is, the one side of the drive part may be connected to the hinge shaft to be rotatably installed, and one end of the operation member may be pivoted by a driving motor connected to the hinge shaft to move the second grain inlet port 311 to the opening or closing position through pivotal movement.

Eventually, the certain amount of grains can be inserted by the supply screw rotated at a certain speed so that the processed grains can be discharged with a uniform density and size, securing reliability in quality of products. In addition, various grains inserted in a dry state can be continuously produced in a jellylike state by crushing and heating the grains using the process screw 320 during conveyance of the grains.

Further, the process screw 320 and the grain discharge path are tapered so that the processed grains can be rapidly discharged at a high pressure. Furthermore, the confectionery production apparatus is operated only when the grains are inserted and an automated system is applied to be operated only when it reaches a preset reference temperature, providing convenient use and ensuring operation at the reference temperature only and thus reducing process inferiority such as mixing of solid grains.

While the technical spirit of the confectionery production apparatus of the present invention has been described with reference to the accompanying drawings, it has been merely described as the best mode for the illustrative purpose without limiting the present invention.

As can be seen from the foregoing, a certain amount of grains are inserted by a supply screw rotated at a certain speed so that the processed grains can be discharged with a uniform density and size, obtaining reliability in performance of products.

In addition, a process screw crushes and heats the grains during conveyance of the grains so that various grains inserted in a dry state can be processed in a jellylike state to be continuously discharged.

Further, the process screw and the grain discharge path are tapered so that the processed grains can be rapidly discharged with a high pressure.

Furthermore, since an automated system is applied such that the confectionery production apparatus is operated, only when insertion of the grains is detected and it arrives at a predetermined reference temperature, to provide convenient use and ensure operation at the reference temperature, is it possible to reduce process inferiority such as mixing of confectionery with solid grains.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An apparatus for producing confectionery comprising:
a grain processing unit installed on a main body, crushing inserted grains, and processing and discharging the grains in a jellylike state using frictional heat generated when the grains are crushed;
a drive unit for driving the grain processing unit; and
a controller for controlling the drive unit.

2. The apparatus according to claim 1, wherein the grain processing unit is configured to receive grains through a grain supply unit, and the grain supply unit is configured to be rotated by drive of the drive unit.

3. The apparatus according to claim 1, wherein the grain processing unit comprises:
a discharge pipe installed on the main body and having a second grain inlet port and a second grain discharge port on opposite sides thereof in a longitudinal direction; and
a process screw installed in the discharge pipe and rotated by the drive unit to process the grains.

4. The apparatus according to claim 3, wherein a spiral pipe, in which the process screw is fitted, is installed in the discharge pipe, and a thread is formed in an inner circumference of the spiral pipe to contact the process screw and crush the grains.

5. The apparatus according to claim 4, wherein the grains are processed into a jellylike state due to frictional heat generated during collision of the grains with the thread.

6. The apparatus according to claim 4, wherein the thread has protrusions having the same or irregular shapes to increase crush efficiency of the grains.

7. The apparatus according to claim 5, wherein the frictional heat ranges from 110° C. to 120° C.

8. The apparatus according to claim 4, wherein the thread formed in the inner circumference of the spiral pipe is engaged with a spiral formed on an outer circumference of the process screw, and has a tapered shape such that a diameter thereof gradually reduces toward the second grain discharge port.

9. The apparatus according to claim 2, wherein the grain supply unit comprises:
a supply pipe installed on the main body and having a first grain inlet port and a first grain discharge port formed on opposite sides thereof in a longitudinal direction; and
a supply screw installed in the supply pipe and rotated by the drive unit so as to guide the grains to the grain processing unit.

10. The apparatus according to any one of claims 1, further comprising a cooling unit for cooling the grains discharged in a jellylike state.

11. The apparatus according to claim 10, wherein the cooling unit performs a cooling operation such that a frictional heat temperature in the grain processing unit is maintained within a range of 110° C. to 120° C.

12. The apparatus according to any one of claims 1, further comprising a cutting unit operated under control of the controller to cut the grains discharged in a jellylike state or a cooled state into a certain length.

13. The apparatus according to any one of claims 1, further comprising a grain detection unit for detecting a supply state of the grains from the grain supply unit to the grain processing unit and outputting the detection signal to the controller,
wherein the controller is configured to drive the drive unit only when the detection signal of the grain detection unit is applied.

14. The apparatus according to any one of claims 1, further comprising an opening/closing unit operated under control of the controller to be converted into a grain blocking state when a temperature in the grain processing unit is equal to or lower than a preset reference temperature and converted into a grain insertion state when the temperature in the grain processing unit is higher than the preset reference temperature,
wherein the controller has a set value of the reference temperature for the temperature in the grain processing unit to control opening/closing operation of the opening/closing unit.

15. The apparatus according to claim 10, wherein the cooling unit comprises:
a housing installed in the second grain discharge port and having an air circulation path formed therein; and
an air supply part connected to the path to circulate air and cool the discharge pipe through which the grains in a jellylike state are discharged.

16. The apparatus according to claim 12, wherein the cutting unit comprises:
at least one cutting blade rotatably connected to the main body via a shaft and rotated about the shaft; and
a drive part connected to the shaft of the cutting blade and driven under control of the controller to transmit a rotational force.

17. The apparatus according to claim 16, wherein the cutting blade has a concave part formed at a rotational end to cut the discharged grains while surrounding the grains.

18. The apparatus according to claim 13, wherein the grain detection unit is installed on a sidewall in the first grain inlet port to detect insertion of the grains from the grain supply unit to the grain processing unit.

19. The apparatus according to claim 14, wherein the opening/closing unit comprises:
a through-hole formed at one side of the second grain inlet port;
an operation member installed in the second grain inlet port to project from and withdraw into the through-hole and moving to an opening or closing position to determine insertion of the grains to the grain processing unit;
a drive part driven under control of the controller and moving the operation member to the opening or closing position; and
a temperature sensor for detecting a temperature in the second grain inlet port and applying a temperature detection signal to the controller.
